(19) United States
(12) Patent Application Publication
(10) Pub. No.: US 2026/0369452 A1
(43) Pub. Date: Nov. 19, 2026

(54) CONTRA-WOUND ELECTROMAGNETIC COIL

(71) Applicant: Zachary Michael de George, Stanton, MI (US)

(72) Inventor: Zachary Michael de George, Stanton, MI (US)

(73) Assignee: Zachary Michael de George, Stanton, MI (US)

(21) Appl. No.: 19/210,791

(22) Filed: May 16, 2025

(51) Int. Cl. H01F 7/18; H01F 7/06; H01F 7/08; H01F 7/127; H01F 27/00; H01F 27/40

(52) U.S. Cl. CPC H01F 7/18; H01F 7/081; H01F 7/127; H01F 27/006; H01F 27/402; H01F 2007/062

(57) ABSTRACT

A contra-wound electromagnetic coil (CWEC), distinct from classical electromagnetic coils, comprises a contra-wound coil composed of a primary coil and a secondary coil wound in opposing directions around a shared core (solid, shelled, or hollow), connected in series at a shared tap, with a magnetic coupling coefficient greater than 0.9. The coils' opposing magnetic fields and an electrical short between the tap and the secondary coil's remaining terminal facilitate back EMF cancellation, reducing effective inductance and enabling rapid current activation. This 2-node inductive device achieves a peak current time of ~34 ns and a settling time of ~500 ns when energized with a 13.1 V lead-acid power supply, representing a 99.975% reduction in activation time compared to classical coils of equivalent inductance (e.g., 356 μH). The CWEC's frequency bandwidth of ~5.4 MHz offers a high-frequency response improvement of ~13,567 times over a classical coil's ~398 Hz, supporting operation from 1 Hz to 100 MHz. Optimized with a secondary coil of 2-3 turns and an optional added capacitor (0.1-20 μF for most cases) in series with the tap short to suppress parasitic secondary coil current, the CWEC enhances performance in high-frequency applications. Potential uses span defense and space, automotive, audio (e.g., 44.1 kHz speakers), telecommunications, energy-efficient devices, sensors, high-speed switches, EMI shielding, fusion systems, particle accelerators, and EMP protection, leveraging rapid activation and increased frequency bandwidth for improved efficiency and functionality.

### CROSS-REFERENCE TO RELATED APPLICATIONS

Not Applicable.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION-BY-REFERENCE OF MATERIAL SUBMITTED ON A READ-ONLY OPTICAL DISC OR AS A TEXT FILE OR AN XML FILE VIA THE PATENT ELECTRONIC SYSTEM

Not Applicable.

### STATEMENT REGARDING PRIOR DISCLOSURES BY THE INVENTOR OR A JOINT INVENTOR

Not Applicable.

### TECHNICAL FIELD

This disclosure relates to a contra-wound electromagnetic coil (CWEC), a novel electromagnetic coil design, distinct from classical inductors, such as the original electromagnet disclosed by William Sturgeon in 1825. Traditional electromagnetic coils generate magnetic fields from electrical currents, or electrical currents from magnetic fields, with properties governed by conventional coil winding geometries that often result in delayed current activation. The CWEC introduces a simple and unique winding and coupling arrangement of two contra-wound coils, with an added short between the tap and secondary coil that facilitates back EMF cancellation, enabling rapid current activation behavior. The CWEC can be fabricated using current winding techniques, with the possible ability to retrofit existing traditional coils to a CWEC configuration, such as the ITER Central Solenoid or ATLAS Barrel Toroid @ 2025 Zachary Michael de George (Large Hadron Collider), each containing inductors as large as ~1000 H. The CWEC achieves rapid current activation compared to its conventional counterpart, with a current transient that varies from the exponential saturation waveform of classical inductors, taking the shape of a step-response to an underdamped second-order system. This results in a peak current time around ~34 ns and a steady-state in ~500 ns, as measured on various CWEC embodiments of up to 25 mH primary coil inductance under a 13.1 V lead-acid power supply with a short circuit current of 140 A. This compares to saturation times of classical coil counterparts measured in dozens of milliseconds, resulting in a considerable decrease, greater than 99.99%, in activation times for the CWEC embodiment of even a modest inductance, with an additional greatly increased frequency bandwidth over 10,000 times the bandwidth of a comparable classical counterpart, positioning the CWEC for significant advancements in low-latency and high-frequency electromagnetic applications, such as magnetic confinement fusion, particle accelerators, and pulsed power systems for directed energy applications, amongst many other applications throughout the defense and space, aeronautical, automotive, industrial, consumer industries as well as in the scientific and research communities.

### BACKGROUND OF THE INVENTION

The statements in this section provide background for the present disclosure and do not constitute prior art. For the purposes of this document, the term “device” refers to any arrangement of elements or components designed to perform a predictable and repeatable function. The term “electromagnetic coil” denotes any coil of conductive material that generates a magnetic field from an electrical current or, conversely, produces an electrical current from a magnetic field, and may function as a sub-component in a complex system, such as a single phase in a 3-phase motor, or as a standalone component, such as a single electrical solenoid. Additionally, the terms “classical,” “traditional,” and “conventional,” when used in relation to electromagnetic coils, are interchangeable and refer to inductors exhibiting an exponential current saturation transient, a characteristic that limits rapid activation and high-frequency response in such coils, as addressed by the present disclosure. The term “activation,” when used to describe an electromagnetic coil, refers to the time taken to reach an activated state, whose methods varies depending on the coil's design—for example, the saturated time for classical inductors (where the coil is 99% saturated), or a combination of peak and steady-state times (where oscillations are under 2%) for current transients that are of a step-response to an underdamped second-order system.

Inductors, one of the three fundamental electrical components alongside resistors and capacitors, are passive electrical elements (do not introduce energy into a system) that store electrical energy in a magnetic field. Unlike resistors, characterized by linear resistance, inductors exhibit impedance, specifically reactance, which opposes alternating currents. Inductance, governed by Faraday's law of induction, generates a voltage opposing changes in current in an inductor. In a direct current system, this impedance results in an exponential current increase until saturation based on the time constant τ=L/R, with L being inductance in Henries, and R resistance in Ohms, often measured in millisecond values. For an uncharged inductor in an RL circuit with a constant voltage source, the current growth is described by the equation:

I(t)=Iₘₐₓ(1−e^{-t/τ}) (Eq. 1)
where:
   t is time in seconds,
   I(t) is the current transient through the inductor,
   Iₘₐₓ is the maximum current (saturation current),
   T=L/R is the time constant.
      This response is governed by Faraday's Law of Induction, where a voltage is generated in inductors that opposes changes in current, which will offset an applied voltage, reducing its effective value. According to Ohm's Law of V=IR, or rearranged as I=V/R, there is a linear relationship between voltage and current. This decrease in effective voltage across an inductor slows the current rise, leading to a delayed response, until the current reaches a saturated steady-state value. Upon disconnection from a power source, a charged inductor releases all its stored magnetic energy as a back EMF spike, often visible as a spark in applications like solenoid switches, which is manageable with additional components such as diodes or capacitors to mitigate the electromagnetic interference (EMI) and protect circuits from high voltage and current spikes. Permeability (H/m), a material property that enhances an inductor's magnetic flux density, additionally improves inductor performance and enables designs with materials of varying permeability, such as those used in advanced solenoid configurations.

The inductive voltage opposition to current changes in classical inductors and electromagnetic coils results in delayed current saturation, and therefore activation times, a limitation that has presented a significant engineering obstacle ever since the electromagnet's original invention two centuries ago. Prior art, identified through several searches, reveals various attempts to address this delayed activation through electrical, mechanical, or structural modifications, often relying on supplementary electronics, heavy machinery, complex software, or reliance on permeable materials. For example, in high-frequency applications like automotive ABS solenoids, traditional solenoids operate in reverse-logic—energized to keep the valve closed and de-energized to open it for braking—for a response quick enough to be used in an ISO 26262 ASIL D 1,000 Hz real-time system, imposing increased power consumption, heavy reliance on permeable materials, and increased software complexity as trade-offs to meet acceptable activation times for this system's requirements. Accordingly, there remains need for an innovation to overcome the slow current saturation limitation of classical inductors and electromagnetic coils, particularly for applications requiring rapid response times or high-frequency response, a need addressed by the current CWEC design achieving rapid peak current and settling times through back EMF cancellation, enabling the CWEC for use in kHz-range real-time applications, such as those in defense and space, aeronautical, and automotive industries.

### BRIEF SUMMARY OF THE INVENTION

A contra-wound electromagnetic coil (CWEC) is disclosed for applications requiring rapid electromagnetic activation and enhanced high-frequency response. The CWEC comprises primary and secondary coils wound in opposing directions with a shared tap, magnetically coupled with a coefficient optimally exceeding 0.9. The coils may incorporate additional materials of varying permeability in or around a solid, shelled, or hollow core to enhance the arrangement and therefore performance. A short connects the tap to the secondary coil's remaining terminal, designated as one of the CWEC terminals, with the primary coil's remaining terminal designated as the other terminal of the 2-node CWEC. Notably, the solenoid's magnetic polarity remains consistent regardless of which coil is designated as primary or secondary, although their inductances may differ, so specific coil designation remains necessary for proper design. This configuration facilitates back EMF cancellation between the two coils that enables the rapid current activation. Performance is optimized by limiting the secondary coil's turns to small values, such as 2 or 3 turns, minimizing material usage as well as parasitic current through the secondary coil, while preserving the rapid current activation and response of the CWEC. The shape of this response, in the form of a step-response to an underdamped second-order function, is independent of the primary coil's inductance or turn count. Prototypes ranging from a few μH to dozens of mH, all tested on the same 13.1 V lead-acid power supply, exhibit consistent primary current activation responses, reaching peak current at ~34 ns and settling at a steady-state value around 1 μs, with larger designs demonstrating the same timing but with statistically greater improvements over their classical coil counterparts, all in embodiments with Nₛ=2 or 3. For a 25.1 mH prototype, the reduction in activation time (t_{steady-state} of CWEC vs tₛₐₜᵤᵣₐₜᵢₒₙ of classical coils) approaches 99.9988%. Additionally, adding a capacitor, typically with a small capacitance of 0.1-20 μF selected proportional to the primary coil inductance, in series with the short between the shared tap and secondary terminal suppresses the parasitic current through the secondary coil while maintaining the rapid activation behavior of the primary coil, further optimizing performance by inhibiting parasitic current through the secondary coil. The back EMF cancellation in the CWEC occurs because the shorted secondary coil generates a current that produces a magnetic field opposing the primary coil's field, reducing the net flux change and thus the effective inductance and opposing voltage seen across the inductor. This increases the effective voltage, allowing the current to rise much faster in CWEC embodiments, making the CWEC highly effective for applications requiring rapid activation and increased frequency bandwidth, such as high-speed inductive applications across electronics and other related industries. Rigorous testing confirms the CWEC's superior current activation, demonstrating its high-frequency response compared to traditional electromagnetic coils and positioning the CWEC as a new source of innovation and technological advancement.

This summary merely introduces key concepts and essential features of the claimed subject matter, which is distinct from prior art by the addition of the short between the tap and secondary coil.

### BRIEF DESCRIPTION OF THE SEVERAL VIEWS OF THE DRAWINGS

FIG. 1 is a system diagram of a contra-wound electromagnetic coil (CWEC), illustrating its core components and configuration within an enclosure (1), which may be conceptual or physical. A coupling (2) with a high degree of magnetic coupling, typically exceeding a coefficient of 0.9, facilitates interaction between the primary coil (3), labeled COIL_{P}, and the secondary coil (4), labeled COIL_{S}. The primary coil (3) has a polarity (5) and NP turns (7), while the secondary coil (4) has an opposing polarity (6) and NS turns (8). These coils are connected in series at a shared tap (9), where the winding direction reverses. An electrical short (13) links the tap (9) to the secondary coil's remaining terminal, designated TERM_{B} (12). The device's overall polarity (10) depends on the coil orientations (5, 6) and the applied power polarity. The primary coil's remaining exposed terminal, labeled TERM_{A} (11), defines the other node of a 2-node inductor device, where the two nodes refer to the external connection points TERM_{A} and TERM_{B}. This configuration enables rapid current activation and increased high-frequency response compared to classical inductors.

FIG. 2 depicts a single-wire CWEC (CWEC-1), featuring a magnetic coupling with a shared cylindrical core geometry (16), which may be solid or shelled (17). A single wire, WIRE 1, winds in a contra-wound pattern, creating opposing current flows (20, 21) in the primary and secondary coils. The tap (18), marking the point of winding reversal, is shorted (19) to the secondary terminal, labeled TERM_{B} (14). The primary coil's other terminal, labeled TERM_{A} (15), is exposed, configuring a 2-node device with the desired rapid current activation and enhanced high-frequency behaviors.

FIG. 3 shows a two-wire CWEC (CWEC-2), with a magnetic coupling from a shared cylindrical core (24), which may be solid or shelled (25). Two wires, WIRE 1 and WIRE 2, are wound to create opposing magnetic fields and are connected in series at the tap (22), which links one terminal of each coil. The tap (22) is also connected to the secondary coil's remaining terminal, effectively forming TERM_{B} (22) by joining both secondary terminals and one primary terminal into a single node due to the shorted connection. The primary coil's other terminal, labeled TERM_{A} (23), designated the second node, creating a 2-node device equivalent to CWEC-1 with rapid current saturation and increased high-frequency response.

FIG. 4 illustrates an optimized CWEC (CWEC-2o) with a magnetic coupling from a shared cylindrical core (28), which may be solid or shelled (29). Two wires, WIRE 1 and WIRE 2, are wound to produce opposing magnetic fields, with the secondary coil optimized to N_{S}=2 turns to minimize material usage and secondary current while retaining rapid current activation and enhanced high-frequency response. The coils are connected in series at the tap (27), which is also connected to the secondary coil's remaining terminal, forming TERM_{B} (27) as a single node due to the shorted connection. The primary coil's remaining terminal, labeled TERM_{A} (26), serves as the second node, configuring an optimized 2-node device.

FIG. 5 presents an improved CWEC (CWECi) within an enclosure (30), which may be conceptual or physical, with a coupling (31) providing high magnetic coupling between the primary coil (32), labeled COIL_{P}, and the secondary coil (33), labeled COIL_{S}. The primary coil (32) has a polarity (34) and NP turns (36), while the secondary coil (33) has an opposing polarity (35) and NS turns (37). The coils are connected in series at the tap (38), where the winding direction reverses. A capacitor (39), labeled C, with a capacitance typically in the range of 0.1-20 μF selected proportional to the primary inductance, is placed in series between the tap (38) and the secondary coil's remaining terminal, forming TERM_{B} (43). The tap (38) and TERM_{B} (43) are effectively a single node due to the connection of the three wire ends (one from the primary, two from the secondary) through the capacitor, which acts as a high-pass filter to hasten secondary current decay. The device's overall polarity (41) depends on the coil orientations (34, 35) and the applied power. The primary coil's remaining exposed terminal, designated TERM_{A} (42), serves as the second node, enhancing rapid current saturation while retaining high-frequency response in a 2-node device.

FIG. 6 depicts an improved and optimized CWEC (CWEC-2io) with a cylindrical core, where two wires, WIRE 1 and WIRE 2, are wound to produce opposing magnetic fields, forming primary and secondary coils with the secondary optimized to N_{S}=2 turns. The coils are connected in series at the tap (44), where the winding direction reverses. A capacitor (46), with a capacitance in the range of 0.1-20 μF selected proportional to the primary inductance, is placed in series between the tap (44) and the secondary coil's remaining terminal, effectively forming TERM_{B} (44) as a single node due to the connection of the three wire ends through the capacitor, which acts as a high-pass filter. The primary coil's other terminal, labeled TERM_{A} (45), forms the second node of the CWEC, configuring an improved and optimized 2-node device with enhanced rapid current saturation and increased high-frequency response.

FIG. 7 depicts a waveform of the current transient through the primary coil of a CWEC. The x-axis represents time (46), the y-axis represents current (47), and the waveform (48) shows the current transient through the primary coil of an uncharged CWEC. This waveform is characterized as a step-response to an underdamped second-order function, exhibiting overshoot, decaying oscillations, and an eventual steady-state value. The peak current time (49), occurs at ~34 ns, and the steady-state time (50), is where the current approaches its steady-state value with less than 2% oscillations, typically around ~500 ns. This graph is shown for demonstrative purposes only and does not represent the exact behavior of every CWEC embodiment. It is merely used to provide an example of a current transient waveform that displays all of the same features of an exemplary CWEC embodiment.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the subject matter of the present disclosure. Appearances of the phrases “in one embodiment,” “in an embodiment,” and similar language throughout this specification may, but do not necessarily, all refer to the same embodiment. Various embodiments of the present invention will be described in detail with reference to the drawings, where reference numerals represent parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” The term “based upon” is not exclusive and allows for being based on additional factors not described, unless the context clearly dictates otherwise. Additionally, in the subject description, “exemplary” means serving as an example, instance, or illustration. Any embodiment or design described herein as “exemplary” is not necessarily to be construed as preferred or advantageous over other embodiments or designs. Rather, the use of the word exemplary is intended to present concepts in a concrete manner.

The contra-wound electromagnetic coil (CWEC) introduces a novel configuration, with the initial embodiment created by reversing a cylindrical coil back upon itself after a 180-degree pivot to form a tap, which was then shorted to one of the remaining terminals-a design distinct from prior electromagnetic coils and prior art, undiscovered for nearly two centuries since the electromagnet's original invention. This configuration exhibited distinctive electromagnetic characteristics, visible to the naked-eye, such as a large spark upon brief connections, unlike the behavior of classical inductors, which hinted at its rapid activation functionality. Its mechanism was later clarified through extensive experimentation, confirming the rapid activation and increased frequency bandwidth behaviors.

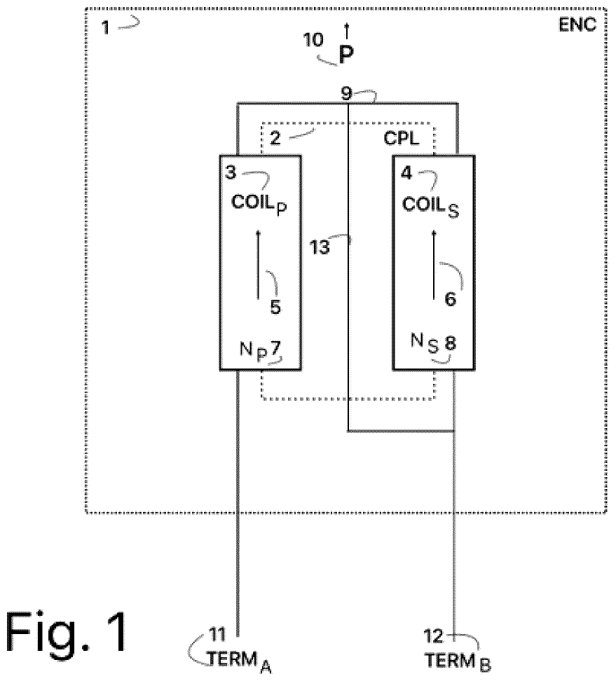

Illustrated in FIG. 1, the CWEC comprises a contra-wound primary coil (3) and a secondary coil (4), magnetically coupled with a high coupling coefficient, typically greater than 0.9 (2). Lower coupling coefficients may still enhance current response, although with reduced efficiency and therefore longer activation times, improvable by using ferrous or permeable materials in or around the core to guide magnetic flux or by refining coil geometry. The coils' polarities (5 and 6) oppose each other, generating magnetic fields in opposite directions, with the primary having NP turns (7) and the secondary NS turns (8), defining a winding ratio NR=NP/NS. A short, effectively a resistor with negligible resistance, connects the tap (9)—where the winding direction reverses—to the secondary coil's remaining terminal (12), and is designated TERM_{B}. The primary coil's remaining terminal (11), designated TERM_{A}, forms the second node of a CWEC, with the overall polarity (10) depending on coil's orientation and power polarity, reversible by swapping power terminals.

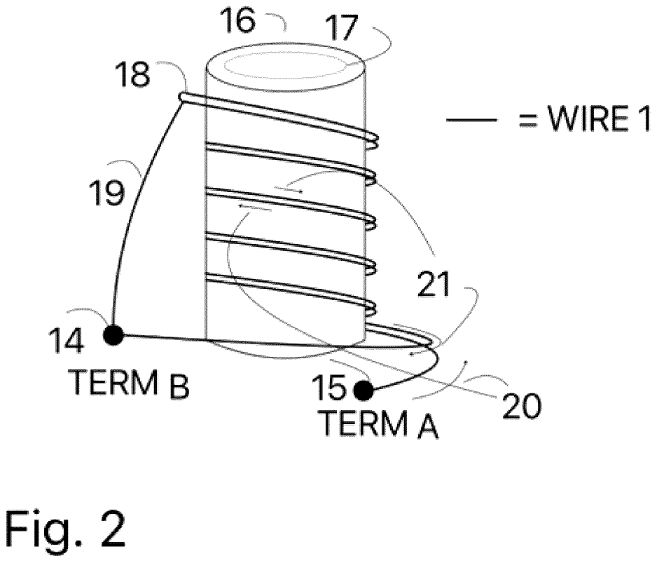

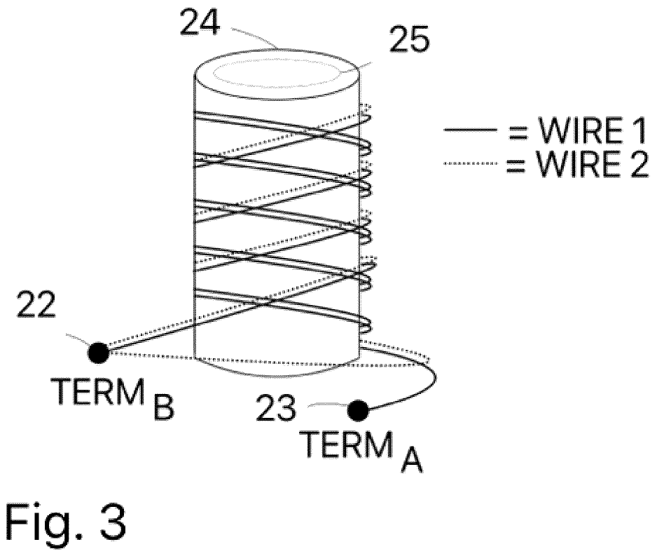

Two fabrication methods produce equivalent CWEC variants. The “single-wire” CWEC (CWEC-1), depicted in FIG. 2, and features a shared cylindrical core (16), solid or shelled (17), facilitating magnetic coupling between the coils with a coefficient above 0.9. A single wire winds in a contra-wound pattern, reversing 180 degrees at the shared tap, creating opposing current flows (20, 21) in the primary and secondary coils. The tap (18) is shorted (19) to the secondary terminal (14), designated TERM_{B}, while the primary coil's other terminal (15), is designated TERM_{A}, configuring a 2-node device with rapid current activation and enhanced high-frequency behaviors. The “two-wire” CWEC (CWEC-2), shown in FIG. 3, uses a shared core (24), solid or shelled (25), with high magnetic coupling (2). Two separate wires are wound to produce opposing magnetic fields, connecting in series at the tap (22), which links one terminal of each coil to the secondary coil's remaining terminal, forming TERM_{B} (22), while the primary coil's other terminal (23), designated TERM_{A}, forms the second node, aligning with FIG. 1's design.

The CWEC's conductive paths, typically insulated or enameled wires, can be made of aluminum, copper, gold, silver, or other metallic or non-metallic conductive material. Additionally they could be solid-core, stranded-core, flat wires to increase conductivity while minimizing resistance, or utilize specialty wires such as Litz wires to mitigate high-frequency parasitic effects such as the skin and proximity effects. Material choice affects resistance and peak (Iₚₑₐₖ) and steady-state (I_{steady-state} or Iₛₛ) currents, with options favored for minimizing resistance and cost based on availability. However, the rapid current activation and high-frequency response stem from magnetic coupling and back EMF cancellation via the shorted tap, creating a low-inductive channel through the coils, unlike during the activation of classical inductors. This cancellation reduces effective inductance by generating an opposing back EMF in the shorted secondary coil, decreasing the overall back EMF and allowing for faster current rise.

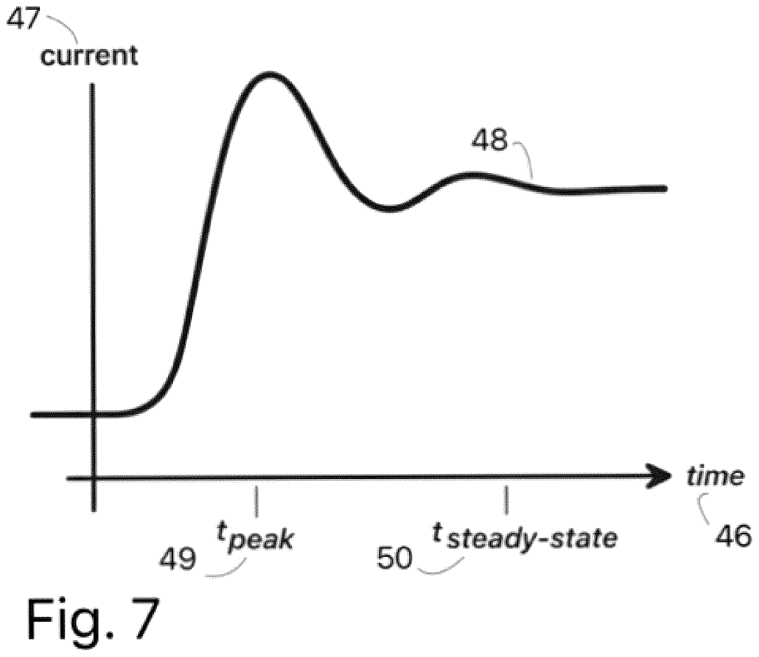

Extensive experiments with a GHz-sampling-rate oscilloscope have characterized the CWEC's behavior. When a DC source is applied, the primary current, Ip (t), follows a step-response to an underdamped second-order function, surging to a ~25% overshoot at tₚₑₐₖ≈~34 ns, oscillating, damping, and settling at t_{steady-state}≈~500 ns, contrasting with a classical coil's exponential saturation, tₛₐₜᵤᵣₐₜᵢₒₙ. This is visually represented in FIG. 7, where the waveform (48) shows the characteristic step-response, with the x-axis (46) as time and the y-axis (47) as current, exhibiting overshoot, decaying oscillations, and a steady-state value. The peak current time tₚₑₐₖ (49) occurs at ~34 ns, and the steady-state time t_{steady-state}, Or tₛₛ (50), reached when oscillations are less than 2%, is ~500 ns. The equation for the primary current is:

$${I}_{P} ( t ) = {I}_{ss} [ 1 - \frac{{e}^{- {ζω}_{n} t}}{\sqrt{1 - {ζ}^{2}}} sin ( {ω}_{d} t + ϕ ) ] \qquad ( Eq . 2 )$$

where:
Iₛₛ is the steady-state current,
ζ is the damping ratio,
ωₙ is the natural frequency,
ω_{d}=ωₙ\sqrt{1−ζ²} is the damped frequency,
φ is the phase angle, and
t is time in seconds.

In this equation, (ζ, ωₙ, φ) are determined by the system's physical properties (e.g., inductance, resistance, capacitance). The secondary current, I_{S}(t\), peaks similarly but decays exponentially based on the primary coil's time constant, reaching peak values of ~0.1-1 A when optimized, compared to the primary coil's Iₛₛ≈150-180 A, with a minimal N_{S}=2-4 turns. The winding ratio NR affects efficiency and the comparison between tₚₑₐₖ, t_{steady-state} and tₛₐₜᵤᵣₐₜᵢₒₙ, but not performance. Early prototypes were CWEC-1 variants and had N_{R}≈1, but later experiments revealed the rapid activation with N_{S} as low as 1-2 turns, and with the CWEC-2 method realized, solutions to minimizing material costs, the parasitic secondary coil current, and fabrication optimization were found.

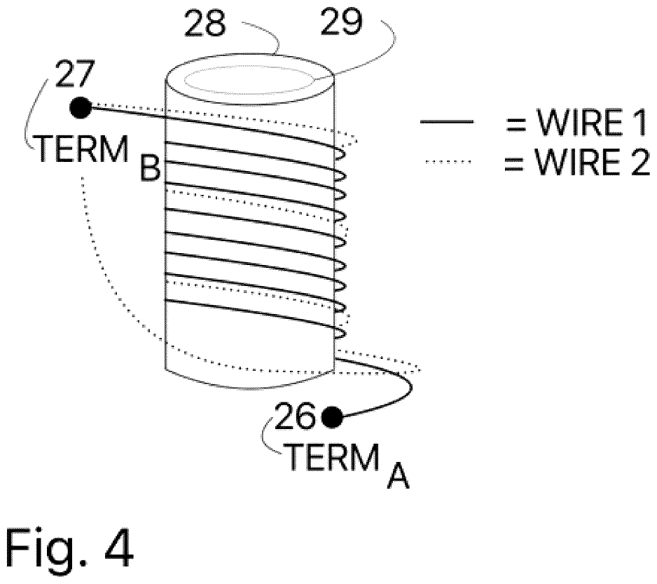

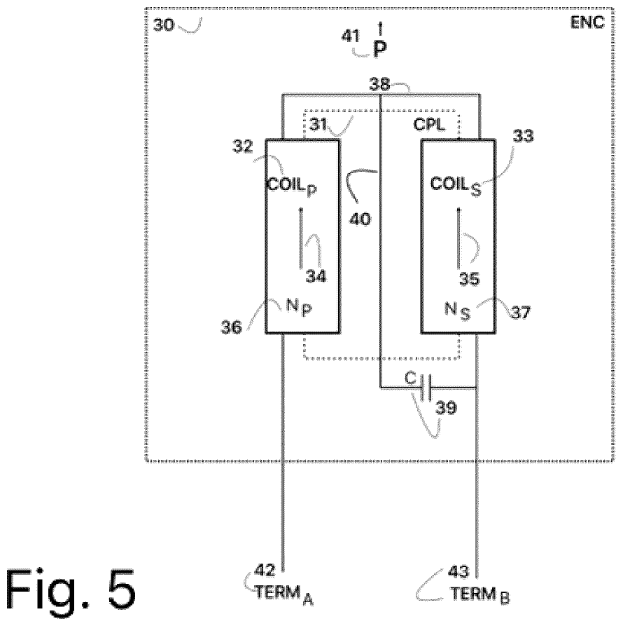

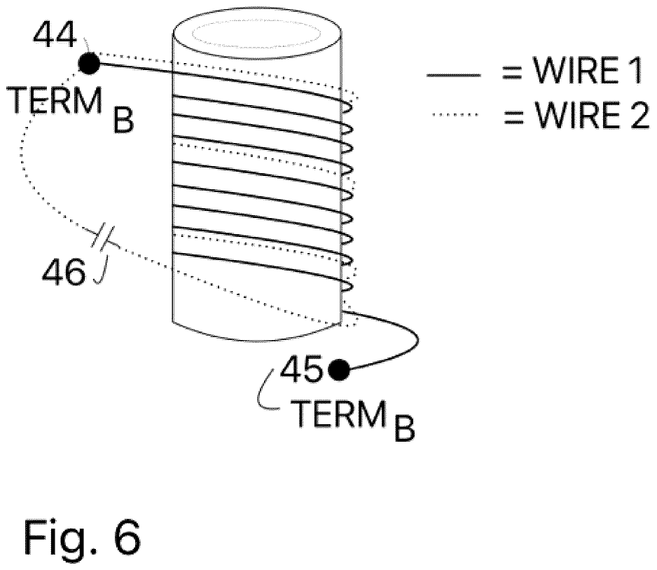

The optimized CWEC-2o, depicted in FIG. 4, uses N_{S}=3 (within the 2-4 range) to minimize material usage while preserving rapid activation, with TERM_{A} (26) at the primary coil's exposed terminal and TERM_{B} (27) linking the other primary terminal to both secondary terminals via the shorted tap. An improved CWEC (CWECi), shown in FIG. 5, incorporates a small capacitor (39), labeled C, typically 0.1-20 μF, selected proportional to the primary inductance, in series with the short between the tap (38) and the secondary coil's remaining terminal (43), forming a high-pass filter to clamp parasitic secondary current without affecting the primary coil's rapid activation. The CWEC-2io, shown in FIG. 6, integrates this with N_{S}=3 and an added 0.1 μF capacitor (46), enhancing performance by suppressing parasitic current while maintaining rapid activation.

The CWEC features rapid current activation, increased frequency response, unique arc behavior when N_{R}≈1 (resulting in a larger arc with brief connection due to an increased I_{S} current magnitude), dual fabrication methods (CWEC-1, CWEC-2), adjustable winding ratios (optimized with N_{S}=2-4), and strong coupling dependency. Potential applications include:
Reducing solenoid current drain in high-frequency real-time applications for energy efficiency,
Enabling higher-fidelity audio speakers,
Supporting high-speed switches,
Enhancing sensors,
Facilitating energy-efficient devices,
Providing EMI shielding (e.g., EMP protection) via rapid field generation to protect critical infrastructure,
Improving magnetic confinement fusion systems by enabling precise magnetic adjustments,
Enhancing particle accelerators, such as the Large Hadron Collider, with improved magnetic focusing.

An experiment with a CWEC-2io embodiment (L_{P}=356 μH, N_{P}=160, N_{S}=3, 0.1 μF capacitor) recorded a peak current at ~34 ns, with t_{steady-state} at ~500 ns, compared to ~2,000 μs for a classical coil of 356 μH inductance to reach tₛₐₜᵤᵣₐₜᵢₒₙ, achieving a ~99.975% reduction in activation time for the relatively small inductor. The additional parameters of the current transient based on Eq. 2 are as follows:
Period of Oscillation Td: ≈178 ns,
Damping Ratio ζ: ≈0.267,
Damped Frequency ω_{d}: ≈3.53×10⁷ rad/s,
Natural Frequency ωₙ: ≈3.66×10⁷ rad/s,
Phase Angle φ: ≈1.30 radians,
Time Constant T: ≈102.3 ns.

Additionally, theoretical calculations based on empirically measured values utilizing the Grok 3.0 AI model by xAI predict that the frequency bandwidth of a CWEC can be estimated to be ≈5.4 MHz compared to a classical coil value of ~398 Hz, for an improvement factor of 13,567. The CWEC's rapid activation (~34 ns peak time, ~500 ns settling time) and high frequency bandwidth (5.40 MHz) make it ideal for applications like magnetic confinement fusion (requiring fast magnetic field adjustments), particle accelerators (needing precise field control), and EMP protection (demanding rapid field generation), as noted previously.

A thorough prior art search, utilizing multiple AI engines and extensive database searches through the University of Michigan's extensive digital library containing domestic and international patent filings and hundreds of reputable journals and publications, contributing to a high confidence in the CWEC's novelty, as no prior art (e.g., U.S. Pat. No. 6,657,846 with opposingly wound coils lacking the short, or U.S. Pat. No. 4,905,962 with fast solenoids lacking contra-wound coils) infringes. Additionally pre-existing classical coils may be converted to CWECs using the CWEC-2 process by adding a secondary coil and short, benefiting large electromagnets like the ITER Central Solenoid or ATLAS Barrel Toroid.

While this disclosure discusses illustrative embodiments, various changes and modifications can be made without departing from the scope defined by the appended claims. Accordingly, the embodiments embrace all such alterations, modifications, and variations within the claims' scope. Elements described or claimed in the singular contemplate the plural unless explicitly limited, and any embodiment's portion may combine with others unless stated otherwise.

### SEQUENCE LISTING

Not Applicable.

### APPENDIX A: EXPERIMENTAL DATA SUMMARY

Experiments conducted on May 1, 2025, validated the CWEC's performance. A CWEC with a 356 μH primary coil and a contra-wound secondary coil, connected via a short, was tested against a classical inductor of equivalent inductance. Frequency bandwidth was calculated without the use of a spectrum analyzer, yielding ~5.4 MHz for the CWEC vs. ~398 Hz for the classical inductor equivalent, a 13,567× improvement. For a 25.1 mH embodiment, a similar 13,564× improvement was observed. Activation time was measured with a high-speed oscilloscope, showing a 99.975% reduction for the CWEC of 356 μH and 99.9988% for a 25.1 mH embodiment with each reaching peak current at the time of ~34 ns and a steady-state time of ~500 ns. Tests were conducted at 25 °C with a 13.1 V lead-acid DC power-supply with a short circuit current value of 140 A, ensuring repeatability.

| Inductance | | Peak time | SS time | Saturation time | | % Change |
|---|---|---|---|---|---|---|
| 356 | μH | ~34 ns | ~500 ns | ~2000 | μs | 99.975% reduction |
| 31.6 | μH | ~34 ns | ~500 ns | ~150 | μs | 99.67% reduction |
| 25.1 | mH | ~34 ns | ~500 ns | ~33.1 | ms | 99.9988% reduction |
| 88.2 | μH | ~34 ns | ~500 ns | ~377 | μs | 99.87% reduction |

1. An electromagnetic coil assembly with rapid current activation and increased frequency bandwidth, comprising:
a contra-wound coil composed of a primary coil and a secondary coil, each having independent windings, connected in series at a shared tap, wound in opposing directions around a shared core that may be solid, shelled, or hollow, such that their magnetic fields oppose each other when current is applied;
a magnetic coupling with a coefficient greater than 0.9, configured to enhance magnetic field interaction between the coils;
an electrical short connecting the shared tap to the remaining terminal of the secondary coil;
wherein the assembly achieves a peak current time of ~34 ns and steady-state time of ~500 ns when energized with a 13.1 V lead-acid power supply, representing a reduction in activation time with increased frequency bandwidth compared to a classical electromagnetic coils of equivalent inductance.

2. A method for achieving rapid current saturation and increased frequency bandwidth in an electromagnetic coil, comprising:
arranging a primary coil and a secondary coil in a contra-wound configuration around a shared core that may be solid, shelled, or hollow, connected in series at a shared tap, such that their magnetic fields oppose each other;
providing a magnetic coupling with a coefficient greater than 0.9 to enhance magnetic field interaction between the coils;
providing an electrical short between the shared tap and the remaining terminal of the secondary coil;
energizing the coil with a 13.1 V power supply, wherein the configuration enables a peak current time of ~34 nanoseconds, representing a reduction in activation time and increased frequency bandwidth compared to classical electromagnetic coils of equivalent inductance.

3. A method for converting a classical electromagnetic coil into a contra-wound electromagnetic coil (CWEC) with rapid current activation and increased frequency bandwidth, comprising:
providing a classical electromagnetic coil wound with a primary wire around a core that may be solid or shelled;
modifying the classical electromagnetic coil by adding a secondary coil wound with a second wire in a contra-wound configuration around the now shared core, such that the primary coil and secondary coil are connected in series at a shared tap and their magnetic fields oppose each other when current is applied;
providing a magnetic coupling with a coefficient greater than 0.9 to enhance magnetic field interaction between the primary coil and the secondary coil;
installing an electrical short connecting the shared tap to the remaining terminal of the secondary coil;
energizing the modified coil, wherein the configuration enables a peak current time of ~34 nanoseconds when energized with a 13.1 V power supply, representing at least a reduction in activation time and increased frequency bandwidth compared to classical electromagnetic coils of equivalent inductance.

4. The electromagnetic coil assembly of claim 1, wherein the secondary coil has N_{S} turns equal to a minimal number, such as 2-4, and the primary coil has a much larger number of turns, N_{P}, such that the winding ratio N_{R}=N_{P}/N_{S} is optimized to reduce material use while maintaining rapid current saturation.

5. The electromagnetic coil assembly of claim 1, wherein the coupling structure includes a core made of, filled with, or surrounded by a ferrous or highly permeable material to strengthen the magnetic field coupling.

6. The electromagnetic coil assembly of claim 1, wherein the primary and secondary coils are wound using a single wire in a contra-wound pattern around the shared core, with the tap marking the point of winding reversal.

7. The electromagnetic coil assembly of claim 1, wherein the primary and secondary coils are formed using two separate wires wound around the shared core, such that their produced magnetic fields oppose each other, with one terminal of the primary coil connected to both terminals of the secondary coil.

8. The electromagnetic coil assembly of claim 1, further comprising a capacitor connected in series with the electrical short between the shared tap and the secondary coil terminal, configured as a high-pass filter to suppress impulse current flow through the secondary coil while maintaining rapid current saturation, with capacitance selected proportional to the primary coil inductance and τ value.

9. The electromagnetic coil assembly of claim 8, wherein the primary coil has N_{P}=160 turns, the secondary coil has N_{S}=2 turns, and the capacitor has a capacitance of 0.1 μF, achieving a peak current time of ~34 ns and settling by ~500 ns with a 13.1 V lead-acid power supply with I_{SS}=140 A.

10. The electromagnetic coil assembly of claim 1, wherein the primary coil has an inductance between 1 μH and 10,000 H.

11. The electromagnetic coil assembly of claim 1, wherein the primary and secondary coils are wound with conductive wire having a diameter of 0.01-100 mm.

12. The electromagnetic coil assembly of claim 1, wherein the conductive material wound for generating the magnetic field are flat bars, cables, or Litz wire to maximize current capacity and decrease resistance while mitigating parasitic high-frequency behaviors such as skin and proximity effect.

13. The electromagnetic coil assembly of claim 1, configured to operate at frequencies between 1 Hz and 100 MHz with an increased frequency bandwidth improvement of at least 1,000% over a classical coil.

14. The method of claim 2, further comprising optimizing the number of turns of the secondary coil, such as setting N_{S}=2-4, to reduce material use while preserving the rapid activation and increased frequency bandwidth effects.

15. The method of claim 2, further comprising installing a capacitor in series with the electrical short between the shared tap and the remaining terminal of the secondary coil, configured to form a high-pass filter that clamps parasitic current flow through the secondary coil while maintaining the rapid activation and increased frequency bandwidth behavior, with the capacitance selected proportional to the primary coil's inductance and τ values.

16. The method of claim 2, wherein the primary coil has an inductance between 1 μH and 10,000 H.

17. The method of claim 2, wherein the primary and secondary coils are wound with conductive wire having a diameter of 0.1-100 mm.

18. The method of claim 3, wherein the secondary coil has N_{S} turns equal to a minimal number, such as 2-4, to reduce material use while preserving the rapid current saturation effect.

19. The method of claim 3, further comprising installing a capacitor in series with the electrical short between the shared tap and the remaining terminal of the secondary coil, configured to form a high-pass filter that suppresses parasitic current flow through the secondary coil while maintaining rapid current saturation, with the capacitance selected proportional to the primary coil's inductance.

20. A system comprising the electromagnetic coil assembly of claim 1, configured for use in high-frequency applications across industries including defense and space, automotive, audio, telecommunications, energy-efficient devices, sensor technologies, high-speed switches, electromagnetic interference (EMI) shielding systems, fusion-core systems, particle accelerators, and EMP applications, wherein the system leverages the CWEC rapid activation and increased frequency bandwidth to improve performance, efficiency, and functionality.
